(19) United States
(12) Patent Application Publication
(10) Pub. No.: US 2025/0325351 A1
(43) Pub. Date: Oct. 23, 2025

(54) CUSTOM SEGMENTED INDIRECT BOND TRAYS

(71) Applicant: LightForce Orthodontics, Inc., Burlington, MA (US)

(72) Inventors: Kelsey A. Fafara, Watertown, MA (US); Samantha Provencher, Merrimack, NH (US); Teryse M. Battiest, Fulshear, TX (US); Christina Bonebreak Jackson, Lexington, MA (US)

(73) Assignee: LightForce Orthodontics, Inc., Burlington, MA (US)

(21) Appl. No.: 19/183,585

(22) Filed: Apr. 18, 2025

Related U.S. Application Data
(60) Provisional application No. 63/636,214, filed on Apr. 19, 2024.

(51) Int. Cl. A61C 7/14; A61C 7/00; A61C 13/34; B33Y 50/00; B33Y 80/00

(52) U.S. Cl. CPC A61C 7/146; A61C 7/002; A61C 13/34; B33Y 50/00; B33Y 80/00

(57) ABSTRACT

Some embodiments relate to techniques of designing indirect bonding (IDB) trays that compensate for factors that affect the bonding success of orthodontic appliance(s) using IDB trays. The techniques apply optimization rules to an IDB tray design to optimize the transfer accuracy of orthodontic appliance(s) to a patient's teeth using IDB tray(s) of the IDB tray design. For example, the techniques may compensate for movement of teeth relative to an initial scan, narrow/wide central arches, teeth planned for extraction, and/or other factors. The techniques may, for example, customize segmentation of IDB trays in an IDB tray design to compensate for factors that affect bonding success.

### RELATED APPLICATIONS

This application claims the benefit under 35 U.S.C. § 119 (e) of U.S. Provisional Patent Application No. 63/636,214 filed on Apr. 19, 2024, entitled “CUSTOM SEGMENTED INDIRECT BOND TRAYS”, which is incorporated herein in its entirety.

### FIELD

This application relates to techniques for designing and manufacturing custom segmented indirect bonding (IDB) trays.

### BACKGROUND

Correct placement of orthodontic appliances for straight-wire orthodontic treatments is important to avoid undesirable tooth movements and extended treatment times. Indirect bonding (IDB) of appliances can achieve greater accuracy and effectiveness of such treatments compared to direct placement of appliances by the clinical professional.

### SUMMARY

Some embodiments relate to techniques of designing indirect bonding (IDB) trays that compensate for factors that affect the bonding success of orthodontic appliance(s) using IDB trays. The techniques apply optimization rules to an IDB tray design to optimize the transfer accuracy of orthodontic appliance(s) to a patient's teeth using IDB tray(s) of the IDB tray design. For example, the techniques may compensate for movement of teeth relative to an initial scan, narrow/wide central arches, teeth planned for extraction, and/or other factors. The techniques may, for example, customize segmentation of IDB trays in an IDB tray design to compensate for factors that affect bonding success.

In some embodiments, the techniques described herein relate to a method for constructing a set of indirect bond trays for transferring one or more orthodontic appliances to one or more respective teeth of a patient, the method including: receiving dentition data associated with a patient; generating a first computer model of teeth of the patient for use in determining placement of the one or more orthodontic appliances on the one or more respective teeth; generating a second computer model of the set of indirect bond trays, the generating including: determining, based on the dentition data and the first computer model, geometries of the set of indirect bond trays using a set of rules designed to optimize transfer accuracy of the one or more orthodontic appliances to the one or more respective teeth of the patient; and constructing, using an additive manufacturing process, the set of indirect bond trays based on the second computer model.

In some embodiments, the techniques described herein relate to a non-transitory computer-readable medium storing instructions that, when executed by a computer hardware processor, cause the computer hardware processor to perform a method for constructing a set of indirect bond trays for transferring one or more orthodontic appliances to one or more respective teeth of a patient, the method including: receiving dentition data associated with a patient; generating a first computer model of teeth of the patient for use in determining placement of the one or more orthodontic appliances on the one or more respective teeth; and generating a second computer model of the set of indirect bond trays, the generating including: determining, based on the dentition data and the first computer model, geometries of the set of indirect bond trays using a set of rules designed to optimize transfer accuracy of the one or more orthodontic appliances to the one or more respective teeth of the patient, wherein the second computer model of the set of indirect bond trays is used in an additive manufacturing process to construct the set of indirect bond trays.

In some embodiments, the techniques described herein relate to an indirect bond tray for transferring one or more orthodontic appliances to one or more respective teeth of a patient, the tray including: an occlusal base defining one or more impressions conforming to at least a portion of one or more respective occlusal surfaces of the one or more respective teeth; and a buccal wall defining one or more respective wells for removably retaining one or more respective orthodontic appliances adapted to be bonded to the one or more respective teeth, the buccal wall extending substantially orthogonally from the occlusal base, wherein a number of the one or more impressions is determined by a set of rules designed to optimize transfer accuracy of the one or more orthodontic appliances to the one or more respective teeth of the patient.

In some embodiments, the techniques described herein relate to a method for constructing a set of indirect bond trays for transferring one or more orthodontic appliances to one or more respective teeth of a patient, the method including: receiving dentition data associated with a patient; generating a first computer model of teeth of the patient for use in determining placement of the one or more orthodontic appliances on the one or more respective teeth; generating a second computer model of the set of indirect bond trays, the generating including: determining, based on the dentition data and the first computer model, geometries of the set of indirect bond trays using a set of rules designed to optimize transfer accuracy of the one or more orthodontic appliances to the one or more respective teeth of the patient; and constructing, using an additive manufacturing process, the set of indirect bond trays based on the second computer model.

In some embodiments, the techniques described herein relate to a non-transitory computer-readable medium storing instructions that, when executed by a computer hardware processor, cause the computer hardware processor to perform a method for constructing a set of indirect bond trays for transferring one or more orthodontic appliances to one or more respective teeth of a patient, the method including: receiving dentition data associated with a patient; generating a first computer model of teeth of the patient for use in determining placement of the one or more orthodontic appliances on the one or more respective teeth; and generating a second computer model of the set of indirect bond trays, the generating including: determining, based on the dentition data and the first computer model, geometries of the set of indirect bond trays using a set of rules designed to optimize transfer accuracy of the one or more orthodontic appliances to the one or more respective teeth of the patient, wherein the second computer model of the set of indirect bond trays is used in an additive manufacturing process to construct the set of indirect bond trays.

In some embodiments, the techniques described herein relate to an indirect bond tray for transferring one or more orthodontic appliances to one or more respective teeth of a patient, the tray including: an occlusal base defining one or more impressions conforming to at least a portion of one or more respective occlusal surfaces of the one or more respective teeth; and a buccal wall defining one or more respective wells for removably retaining one or more respective orthodontic appliances adapted to be bonded to the one or more respective teeth, the buccal wall extending substantially orthogonally from the occlusal base, wherein a number of the one or more impressions is determined by a set of rules designed to optimize transfer accuracy of the one or more orthodontic appliances to the one or more respective teeth of the patient.

The foregoing summary is non-limiting.

### BRIEF DESCRIPTION OF THE DRAWINGS

FIG. 1 shows an example indirect bond (IDB) tray design system (also referred to herein as “the system”), according to some embodiments of the technology described herein.

FIG. 2 shows an example process for designing a set of custom IDB trays and using the IDB trays to bond orthodontic appliances, according to some embodiments of the technology described herein.

FIG. 3 shows an example 3D CAD model constructed by the system for a patient's measured teeth, according to some embodiments of the technology described herein.

FIG. 4A shows a view of a set of teeth with brackets in a target treatment outcome configuration, according to some embodiments of the technology described herein.

FIG. 4B shows view of the brackets in their initial positions, according to some embodiments of the technology described herein.

FIG. 5A shows a view of a model of teeth indicating identified factors based on which segmentation is to be customized according to some embodiments of the technology described herein.

FIG. 5B shows a set of custom IDB trays designed based on the model and rules shown in FIG. 5A, according to some embodiments of the technology described herein.

FIG. 6A shows an example of divergent brackets.

FIG. 6B illustrates scenarios that could occur due to diverging brackets.

FIG. 6C shows an enhanced IDB tray design to address divergent brackets, according to some embodiments of the technology described herein.

FIG. 7 is a block diagram of an exemplary computing device that may be specially configured to implement some embodiments of the technology described herein.

### DETAILED DESCRIPTION

Described herein are techniques for constructing a set of IDB trays for transferring one or more orthodontic appliances to one or more respective teeth of a patient. The techniques improve the accuracy and success of transferring the orthodontic appliance(s) to the one or more respective teeth relative to conventional IDB trays.

Conventional IDB of appliances is performed using “one-size-fits-all” IDB trays. Traditional “one-size-fits-all” IDB trays can fit poorly (i) if a patient's teeth move between the time a patient's mouth is scanned and orthodontic brackets are bonded or (ii) based on individual features of a patient's mouth including arch width, protrusion of gum tissue and spacing between adjacent teeth. Traditional “one-size-fits-all” IDB trays include full arch trays and predetermined segmentation of trays (e.g., front 4 (2-2), canine to molar (3-6), and single tooth only (7s)).

Custom (e.g., patient matched) segmentation of IDB trays can improve IDB tray fit and increase bond success during tray placement and subsequent removal. In addition, brackets can be placed more accurately. Young patients (e.g., around 15 years old or between 10-18 years old, or another age range) often have tooth movement between their initial scan and bonding day, resulting in an increased likelihood of bond failures during the first two weeks of treatment. Narrow and wide central arches can apply to patients of any age. Custom segmentation of IDB trays can also eliminate the need for a clinician to trial fit and/or manipulate IDB trays at the point-of-care (POC).

Patient scans that are submitted for digital treatment plans may not represent the patient's anatomy on the day the patient is to be bonded. While IDB trays may be extremely accurate to the scan provided by a doctor, with brackets placed in their optimal treatment location, if the patient's anatomy is not exactly the same on bonding day as it was during the day of the scan, patients are at risk of a bracket bond failure. For example, in between the time from scan to bond, the patient's teeth may have moved and/or their gums may be more or less inflamed. When the anatomy does not match the scan, the tray may not fit with accuracy leading to movement of the tray (“rocking”) or the tray protruding off of the tooth, which can prevent accurate bonding of the bracket to the tooth or result in too little or too much adhesive between the bracket and tooth.

Even if the patient's teeth do not move, there can be scenarios where an optimal bracket location that enables a straight wire to pass through them at the end of treatment, results in the initial positioning of the bracket relative to an adjacent bracket to not be optimal for bond success. For example, brackets can be pointed towards one another-this causes a “pinch point” in which the tray material fits between two brackets. When removing the tray before a final cure, tray material has to move through a smaller opening creating a higher removal force, which can result in a bond failure. Any scenario where it is difficult to apply even pressure across all brackets in a tray, e.g., extruding canines, spacing, divergent brackets, and/or large spacing between brackets, can result in a bond failure. Narrow or wide arches can also cause issues in tray removal that can lead to bond failure due to tray removal forces.

The inventors have recognized that using a patient's anatomy and bracket placement, potential sources of bonding failures can be identified and mitigated. According to some embodiments of the technology described herein, with digital treatment planning, a set of rules can be applied to customize the segmentation of IDB trays based on the patient's anatomy and bracket placement. In some embodiments, a system may be configured to apply the set of rules to customize the segment of IDB trays. Custom segmentation of IDB trays can improve bracket placement accuracy to decrease bond failures.

In some embodiments, rules can be based on the following attributes (not limited to the following):
Tooth torque, tip, rotation, and/or angulation
Appliance (e.g., bracket or tube) torque, tip, rotation, and/or angulation
Appliance placement location on a tooth level as well as interaction with other teeth/brackets in the mouth
   Appliances may not always be placed on the facial axis (FA) point)
   Appliances can be placed mesial, distal, occlusal, and/or gingival to the FA point
   Appliances can be placed subgingival
Tooth positioning relative to other teeth in the mouth
   For instance an extruding canine, spacing between teeth, overlapping teeth, and/or crowding
   Gingival and/or occlusal distance to adjacent teeth
   Convergence (e.g., rotation or tip) between teeth
Lack of teeth
Appliances to be direct bonded
Mitigating material ingress
Mitigating interference between peripheral material of tray and gum tissue
Divergence of teeth

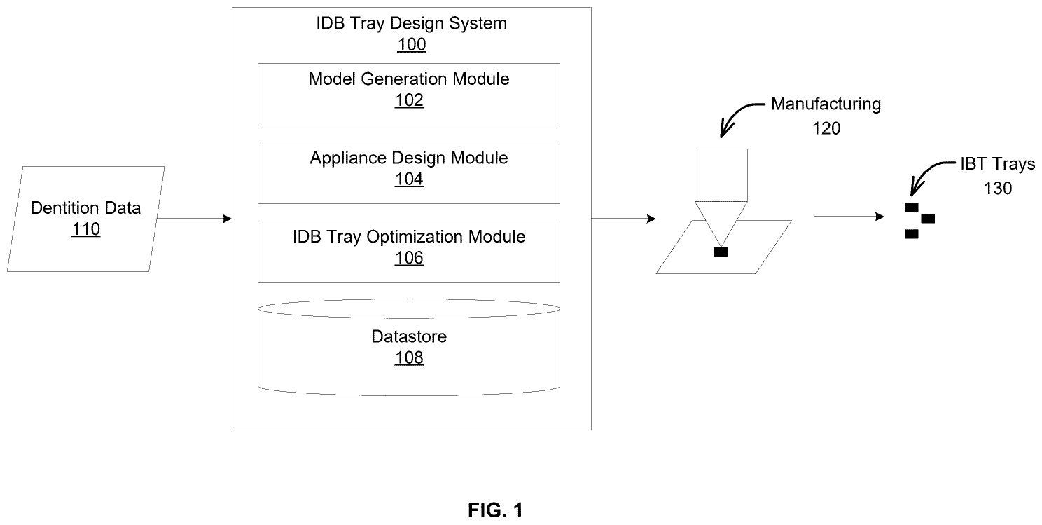

FIG. 1 shows an example IDB tray design system 100 (also referred to herein as “the system 100”), according to some embodiments of the technology described herein. As shown in FIG. 1, the IDB tray design system 100 obtains dentition data 110. The IDB tray design system 100 uses the dentition data 110 to generate a design of a set of IDB trays (also referred to herein as an “IDB tray design”). The set of IDB trays may be designed to optimize transfer accuracy of one or more orthodontic appliances to respective teeth of a patient. In some embodiments, the design of the set of IDB trays may, for example, be specified by a computer model (e.g., a CAD model) of the set of IDB trays. The DIB tray design generated by the IDB tray design system 100 may be used in manufacturing 120 (e.g., additive manufacturing) to construct a set of IBT trays 130 that are optimized for transfer accuracy of orthodontic appliance(s) to respective teeth of a patient.

As shown in FIG. 1, the IDB tray design system 100 includes a model generation module 102, an appliance design module 104, an IDB tray optimization module 106, and a datastore 108.

In some embodiments, the model generation module 102 may be configured to use dentition data 110 to generate a computer model (e.g., a 3D CAD model) of a patient's teeth. In some embodiments, the dentition data 110 may be obtained by performing measurements on the patient's teeth. For example, such measurement may use CT layer scanning a non-contact 3D scanner or an intra-oral scanner directly on the patient's teeth, or may use 3D readings on a teeth model previously cast or 3D printed using a coordinate measuring machine, a laser scanner, or structured light digitizers. In some embodiments, the scanning accuracy can be less than about 0.02 mm.

In some embodiments, the model generation module 102 may be configured to generate a computer model (e.g., a 3D CAD model) of a desired treatment outcome of the patient's teeth. For example, the system may rearrange one or more teeth in an initial computer model of the patient's teeth to obtain the computer model of the desired treatment outcome. In some embodiments, the model generation module 102 may be configured to automatically generate the desired treatment outcome (e.g., by modifying aspects of the initial computer model of the patient's teeth to obtain the desired treatment outcome). In some embodiments, the model generation module 102 may be configured to generate the desired treatment outcome based on user input. For example, the model generation module 102 may use a software application program that provides a graphical user interface (GUI) through which a clinician can provide input to generate the desired treatment outcome (e.g., by modifying aspects of the initial computer model of the patient's teeth to obtain the desired treatment outcome).

In some embodiments, the appliance design module 104 may be configured to generate a design of one or more orthodontic appliances that are to be placed on respective teeth of the patient. The appliance design module 104 may be configured to generate the design of the orthodontic appliance(s) based on the initial model of the patient's teeth and the desired treatment outcome. In some embodiments, the appliance design module 104 may be configured to automatically generate the design of the orthodontic appliance(s). In some embodiments, the appliance design module 104 may be configured to generate the design of the orthodontic appliance(s) based on user input (e.g., obtained through a GUI of a software application for designing orthodontic appliances).

In some embodiments, the IDB tray optimization module 106 may be configured to optimize an IDB tray design for transfer accuracy of the orthodontic appliance(s) to teeth of the patient. The IDB tray optimization module 106 may be configured to obtain (e.g., generate) an initial IDB tray design based on the designed orthodontic appliance(s) and optimize the IDB tray design. In some embodiments, the IDB tray optimization module 106 may be configured to use a set of rules to optimize the IDB tray design. Example rules and application thereof are described herein. The IDB tray optimization module 106 may be configured to use the set of rules by: (1) determining whether certain conditions specified by the set of rules are met, and (2) applying design specifications indicated by the set of rules when the conditions are met. For a particular rule, the IDB tray optimization module 106 may determine whether one or more conditions specified by the rule are met and if it is determined that the condition(s) are met the IDB tray optimization module 106 may apply a design specification indicated by the rule to the IDB tray design (e.g., by segmenting a tray, applying a limit to the number of teeth on a tray, associating a particular set of one or more teeth with a tray, and/or other design specifications). Example such design specifications are described herein.

In some embodiments, the IDB tray optimization module 106 may be configured to iteratively apply the set of rules to the IDB tray design. The IDB tray optimization module 106 may be configured to apply the set of rules to the IDB tray design to obtain a modified IDB tray design. The IDB tray optimization module 106 may be configured to iteratively apply the set of rules until the set of rules no longer triggers any modification to the IDB tray design. Example rules and application thereof are described herein.

In some embodiments, each IDB tray in a set of IDB trays may include an occlusal base defining one or more impressions conforming to at least a portion of respective occlusal surfaces of one or more teeth. The IDB tray may further include a buccal wall defining one or more respective wells for removably retaining one or more respective orthodontic appliances adapted to be bonded to one or more teeth. The buccal wall may extend substantially orthogonally from the occlusal base. In some embodiments, the IDB tray optimization module 106 may be configured to determine a number of impressions in a given IDB tray. The IDB tray optimization module 106 may be configured to determine the number of impressions based on the computer model of the IDB tray. In some embodiments, the IDB tray optimization module 106 may be configured to determine the number of impressions by application of one or more rules of the computer model of the IDB tray.

In some embodiments, datastore 108 may comprise any suitable storage hardware. For example, the datastore 108 may include one or more hard drives for storage of data. In some embodiments, the datastore 108 may store one or more computer models generated by the IDB tray design system 100 (e.g., a computer model of a patient's teeth, a computer model of a desired treatment outcome, a computer model of orthodontic appliance(s), a computer model of an IDB tray design, and/or other computer model(s)). Although the datastore 108 is illustrated as being within the IDB tray design system 100 in FIG. 1, in some embodiments, the datastore 108 may comprise storage external to the system 100. For example, the datastore 108 may comprise a remote database accessible by the IDB tray design system 100.

In some embodiments, an IDB tray design generated by the IDB tray design system 100 may be used in manufacturing 120. In some embodiments, the manufacturing 120 may use additive manufacturing to produce the IDB trays 130. For example, the additive manufacturing may use a computer model of a set of IDB trays to perform an additive manufacturing process that produces the IDB trays 130.

In some embodiments, a produced IDB tray may include an occlusal base defining one or more impressions conforming to at least a portion of one or more respective occlusal surfaces of the one or more teeth. The IDB tray may further include a buccal wall defining one or more respective wells for removably retaining one or more respective orthodontic appliances adapted to be bonded to the one or more teeth. The buccal wall may extend substantially orthogonally from the occlusal base. The number of impressions may be determined by a set of rules (e.g., used by the IDB tray optimization module 106 to optimize transfer accuracy of the one or more orthodontic appliances to the one or more teeth). Example rules that may be used are described herein.

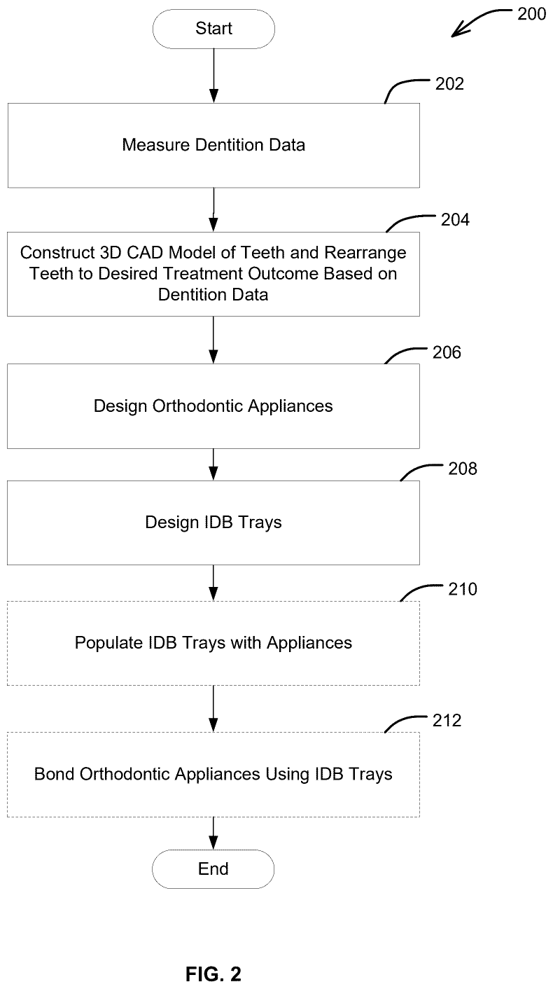

FIG. 2 shows an example process 200 for designing a set of custom IDB trays and using the IDB trays to bond orthodontic appliances, according to some embodiments of the technology described herein. In some embodiments, process 200 may be performed by the IDB tray design system 100 of FIG. 1. Process 200 includes steps 202, 204, 206, 208. Process 200 optionally includes steps 210, 212.

At step 202, the system performing process 200 receives an initial scan of a patient's occlusion (e.g., a doctor submits an initial scan of a patient's occlusion). The measuring process includes measuring dentition data that is received by the system. For example, such measurement may use CT layer scanning, a non-contact 3D scanner or an intra-oral scanner directly on the patient's teeth or may use 3D readings on a teeth model previously cast or 3D printed using a coordinate measuring machine, a laser scanner, or structured light digitizers. In some embodiments, the scanning accuracy can be less than about 0.02 mm.

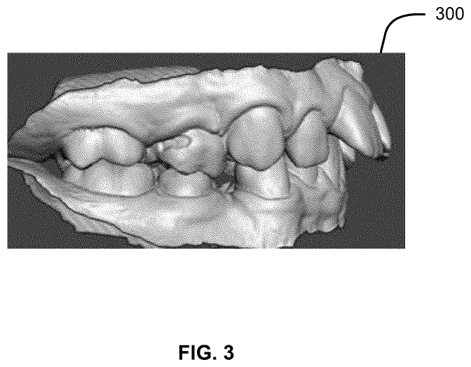

At step 204, based on the given dentition data, the system generates a computer model (e.g., a 3D CAD) model of the measured teeth. The system may be configured to store the model. For example, the model can be saved in a computer in a typical file format, such as the.stl, Additive manufacturing File (AMF) format or any other 3D vector file. FIG. 3 shows an example 3D CAD model 300 constructed by the system for a patient's measured teeth, according to some embodiments of the technology described herein.

At step 204, the system further rearranges the teeth in the model to a desired treatment outcome based on the measured dentition data. For example, the system may use software to rearrange the teeth in the model to the desired treatment outcome. In some embodiments, the system may be configured to receive approval of the treatment outcome (e.g., a doctor approves a treatment plan for a patient with the brackets placed in a position on each tooth which provides the optimal result utilizing a view of the final tooth position generated by the system).

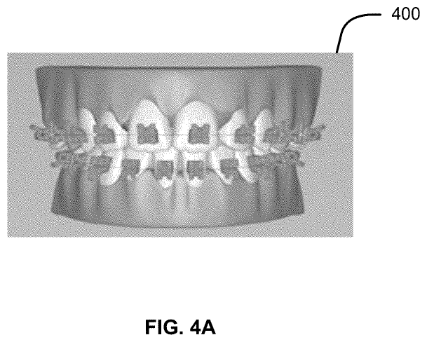

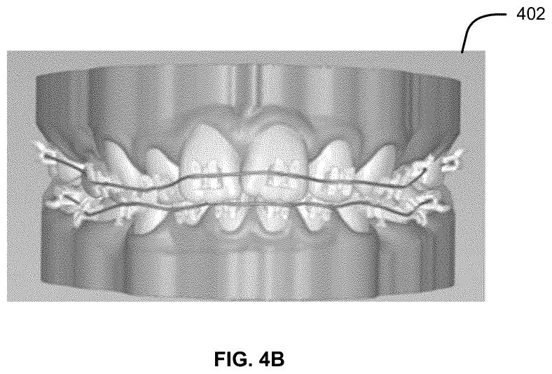

At step 206, the system designs orthodontic appliances. For example, orthodontic appliances are designed using software based on the input 3D CAD model of the measured teeth and the model of the desired treatment outcomes. The orthodontic appliances may be manufactured using any suitable technique. For example, such orthodontic appliances can be manufactured utilizing a direct manufacturing process such as 3D printing or additive manufacturing (AM) (e.g., a ceramic based slurry AM process). FIG. 4A shows a view 400 of a set of teeth with brackets in a target treatment outcome configuration, according to some embodiments of the technology described herein. FIG. 4B shows a view 402 of the brackets in their initial positions, according to some embodiments of the technology described herein.

At step 208, the system designs custom IDB trays. In some embodiments, the system may be configured to design the custom IDB trays using a set of defined rules. The rules may be defined to optimize transfer accuracy of the orthodontic appliances to the teeth of the patient. Example rules are described herein. The system may be configured to use the set of defined rules by analyzing the teeth and bracket placements based on the initial patient malocclusion based on the treatment plan against the set of defined rules for manufacturing custom IDB trays (as set forth below in more detail). A rule may specify specific tray design specifications such as segmenting of a tray in certain conditions, restricting inclusion of an appliance (e.g., a bracket), using a single tray under certain conditions, use of certain types of trays under certain conditions, keep certain teeth together in certain conditions, and/or other design specifications.

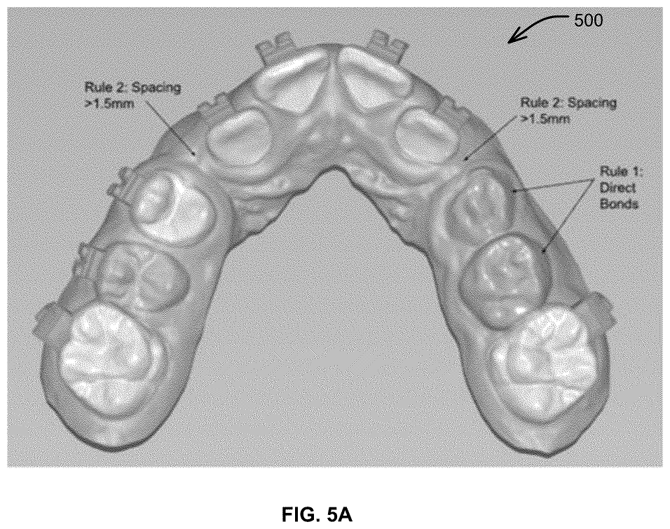

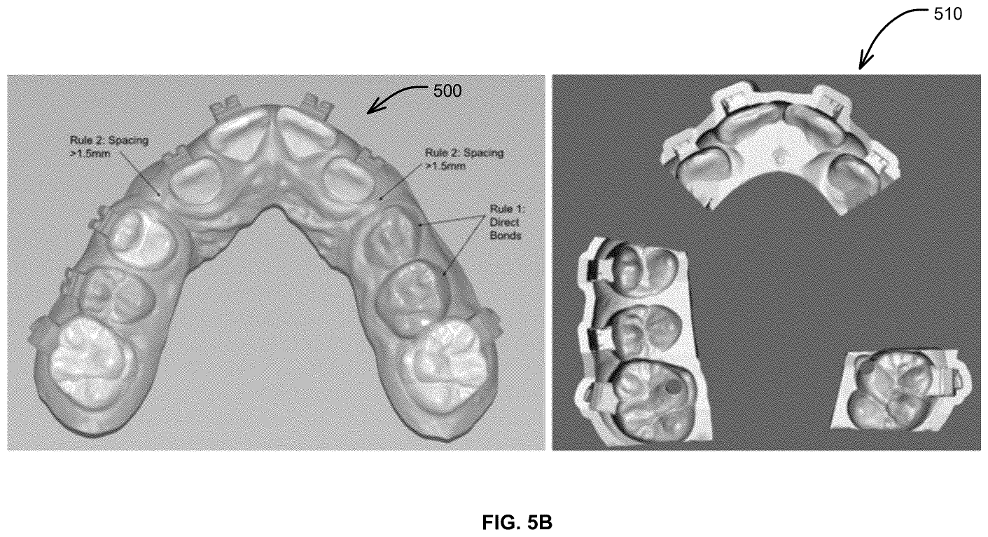

As an illustrative example, the system may be configured to customize segmentation of the IDB trays based on the rules. In some embodiments, when a factor (e.g., a rule, preference, appliance, or other factor) is identified that impacts segmentation, segmentation of the IDB trays is customized. FIG. 5A shows a view 500 of a model of teeth indicating identified factors based on which segmentation is to be customized according to some embodiments of the technology described herein. In the example of FIG. 5A, the identified factors include Rule 1 indicating direct bonds between a pair of teeth Rule 2 indicating that spacing between adjacent teeth is greater than a threshold distance (e.g., 1.5 mm).

In some embodiments, after designing a set of custom IDB trays, the custom IDB trays can be manufactured. In some embodiments, trays can be manufactured before, during or concurrently with design and manufacture of the orthodontic appliances. In some embodiments, trays can be manufactured using a direct manufacturing process, a subtractive manufacturing process such as milling, by forming a cast and molding the tray over the cast, or another suitable manufacturing process. In some embodiments, trays can be formed from a flexible biocompatible material such as silicone, a polymer formed by an AM process, or another suitable material. In some embodiments, a photopolymer resin based on an acrylic ester monomer can be used in an AM process. FIG. 5B shows a set of custom IDB trays 510 designed based on the model and rules shown in FIG. 5A, according to some embodiments of the technology described herein. As shown in FIG. 5B, the set of IDB trays includes three IDB trays.

At step 210, the custom IDB trays are populated with orthodontic appliances, which are bonded to teeth by a clinical professional. In some embodiments, the system may calculate transfer accuracy. Transfer accuracy can be calculated from a deviation of the planned and real bracket positions using a local best-fit alignment (e.g., resulting in three linear and three angular measurements for each bracket). Planned and real bracket positions can be measured using an optical technique or a 3D scanning technique.

In some embodiments, if a tray is segmented, trays can be provided with bridges to connect them into anterior and posterior sections to facilitate proper tooth preparation protocols. The sequence in which trays are used to bond appliances to teeth can be customized. Due to isolation issues, clinicians may prefer to use a particular sequence in which they bond. Posterior teeth can be prepared first because isolation is more difficult to overcome, which can lead to success difficulties because the bond surface is contaminated. In some embodiments, providing trays in sextants also can increase bond success.

In some embodiments, bridges between segments can be cut prior to bonding. Cut indicators (e.g., perforations or markings) on the bridges can be positioned so there is no interference between material and an adjacent tooth. Purchase points for cutting via any method (hands, pliers, scissors, etc.) ensure a cut is completed correctly. Perforations can be any shape, for example, three dimensional polygons, circles, circular arcs. In some embodiments, a bridge may be small enough to prevent positioning a tray without cutting the bridge as it will interfere with the tooth next to it.

In some embodiments, holes can be placed on the most distal tooth in a segment on the upper arch (or lower) to easily identify trays that look similar due to tooth geometry but are intended for a specific arch. In some embodiments, indicators can be placed on the bottom of the tray for each tooth within a segmented tray to properly identify when trays are broken apart to ensure the correct tray is bonded to the correct tooth (tooth structures for molars, premolars and incisors can appear similar, left and right sides of the mouth cane appear similar for corresponding tooth structures).

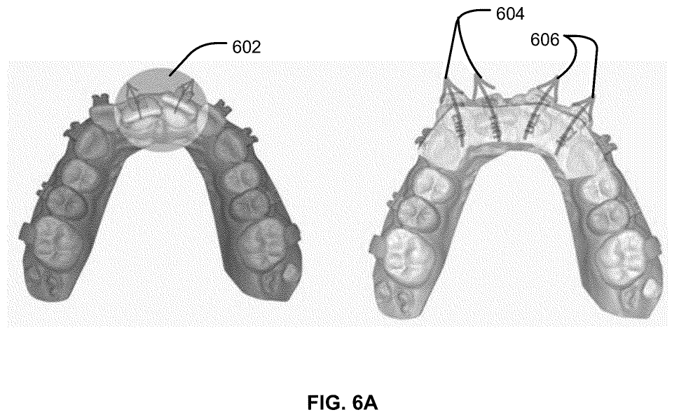

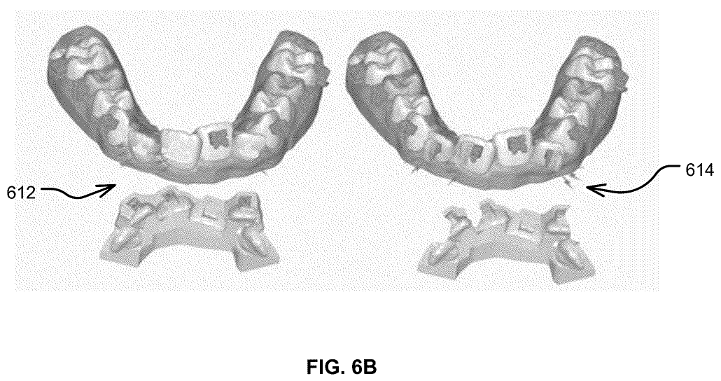

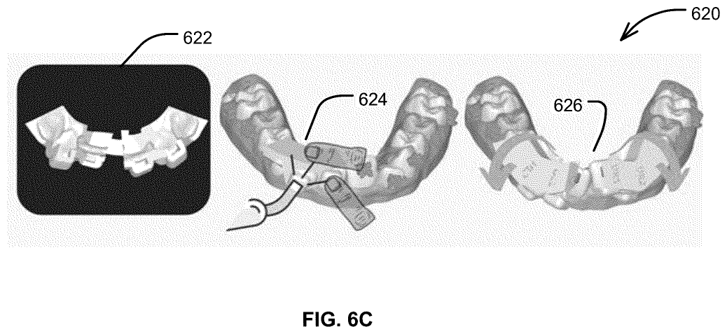

FIG. 6A shows an example of divergent brackets. FIG. 6A shows the divergence 602 between the U1s. Due to this divergence, the removal direction 604 for the UR1-2 differs from the removal direction 606 of the UL1-2 as illustrated in FIG. 6A. FIG. 6B illustrates scenarios that could occur due to diverging brackets. There are various scenarios that could occur if too much force is applied to the divergent teeth with diverging brackets in a 4 bracket tray. There may be either an adhesive detachment 612 from a tooth or a tear of the tray 614 leaving behind pieces of the bracket in the mouth. FIG. 6C shows an enhanced IDB tray design 622 to address divergent brackets, according to some embodiments of the technology described herein. The original tray 622 is segmented such that there are less than four teeth in a tray. The segmented tray fits more focused and controlled as illustrated by reference number 624. Likewise, removal of the segmented trays is easier as illustrated by reference number 626. Example rules that may be used to address IDB tray design for divergent teeth are described herein.

An exemplary set of rules designing indirect bond trays (e.g., that may be used at step 208 of process 200 described herein with reference to FIG. 2) may include one or more of the following rules. In some embodiments, the system may be configured to use the set of rules to design custom IBD trays by: (1) determining whether conditions specified by the rules are met, and (2) when a condition specified by a particular rule is met, applying the particular rule.
Overall
   Maximum of three teeth in a single segment for sides (teeth 3-7) and of 4 teeth for centrals (2-2)
   Segment a tray if the space between adjacent teeth is greater than 1.5 mm
   Do not include direct bonded brackets or teeth not treated into a segment
   Do not include teeth planned to be extracted into a segment
Single Tooth Trays
   For any tooth with a tooth extension greater than 0.3 mm, use a single tooth tray
   For a baby tooth, use single tooth tray for one or more teeth that may contact the baby tooth (e.g., if a U4 tooth is a baby tooth, a single tooth tray can be used for the adjacent U3, U5, L3, L4, and L5)
   For cases with minimal (1-2) occlusal contacts in the whole mouth, use a single tooth tray for all posterior teeth (upper and lower 3-6s)
   In a patient with minor (0-1) occlusal contacts on a segment and with erupting 5s, place 5s in single tooth trays
Second Molar Trays
   Place 7s in a single tooth tray unless:
      Teeth are “locked in” and there are no expected movements
         Place 7s in a single tooth tray if including 7s in a 6-7 tray results in a different tooth being in a single tooth tray (e.g., use a 5-6 tray and a 7 tray if other option is a 5 tray and a 6-7 tray, or a 6 would be a single tooth tray)
      A doctor preference for bonding 7s at the initial appointment
Midline
   Cut the central tray down the midline creating a 1-2 bond tray if intercanine width can be classified as narrow or wide
   Cut the central tray down the midline and Segment 1-2 if the 1-1 brackets are not parallel to the midline
   Cut down the midline Segment 1-3, if there is no shift in directionality from 1-3
   Segment 1-3 instead of 1-2 if intermolar width can be classified as narrow or wide, or there is no shift in directionality from 1-3
   Use a 2-2 central tray if the 1-1 brackets point in the same direction, are in the same vertical plane, are in a straight line in the occlusal view, and the distance between the bracket slots is less than 5.5 mm
   Use a 2-2 central tray if the jaw can be classified as square in the central arch
   If there are minimal occlusal contacts (2 or fewer across the entire mouth) and the central brackets are not on the FA point, then make all brackets (upper and lower 2-2) single-tooth jigs
   If there are minimal occlusal contacts (2 or fewer across the entire mouth) and the central brackets are on FA points, keep the 1-2 or 1-3 configuration
Distances
   If the distance between two brackets is less than 1 mm or greater than 5 mm, split the tray
   Segment a tray when there are spaces >0.5 mm between teeth
   Cut the tray if the space between teeth is greater than 1 mm for females 14 years and younger or males 15 years and younger and spaces greater than 4 mm for all other patients.
   For any tooth with a tooth extension >0.2 mm, use a single tooth tray
Archwire deflections and bracket directions
   If the arch-wire is straight through the slots in the occlusal and facial views, keep those teeth together.
   If there are 4 teeth in a straight line then split them into two jigs with 2 teeth in each tray because overall rule of no more than 3 teeth in a line
   Use a single tooth tray if, looking in the side view, brackets are in a different plane
   Use a 2 tooth tray if the brackets are facing in the same direction, even if they aren't in a straight archwire line
      Brackets facing in the same direction enable the application of even pressure over the brackets in the tray during bonding
   Use a 2 tooth tray if one bracket is more lingually set than both brackets around it (occlusal view) but from the side view the brackets are in a different plane
   If a bracket's directionality differs from the adjacent tooth (convergent or divergent brackets) beyond a threshold, segment the tray
      For example, is there is greater than a 5 degree convergence in any direction (e.g., rotation or tip) between any teeth, cut the tray
Crowding
   If crowding measurement exceeds 4 mm, segment all crowded teeth individually
   If a tooth is more than 0.5 mm or greater gingival to the adjacent tooth, split a segment between the adjacent teeth
Divergent Teeth
   When a tray has 4 or more brackets in it, cut the central tray at the midline for Upper 1-1 angulations less than-45 degrees and Lower 1-1 angulations less than −41.5 degrees. When a central tray contains 4 or more brackets, segment the tray at the midline when the Upper 1-1 brackets diverge by more than 45 degrees and when the Lower 1-1 brackets diverge by more than 41.5 degrees
Segment the posterior tray between the U/L 3 and 4 when brackets diverge by more than 41.5 degrees
Segment tray between upper or lower 3 and 4 (canine and 1st premolar) for angulations more than 41.5 degrees

### Summary of Example Techniques

In some embodiments, the techniques described herein relate to a method for constructing a set of indirect bond trays for transferring one or more orthodontic appliances to one or more respective teeth of a patient, the method including: receiving dentition data associated with a patient; generating a first computer model of teeth of the patient for use in determining placement of the one or more orthodontic appliances on the one or more respective teeth; generating a second computer model of the set of indirect bond trays, the generating including: determining, based on the dentition data and the first computer model, geometries of the set of indirect bond trays using a set of rules designed to optimize transfer accuracy of the one or more orthodontic appliances to the one or more respective teeth of the patient; and constructing, using an additive manufacturing process, the set of indirect bond trays based on the second computer model.

In some embodiments, the techniques described herein relate to a method, wherein determining, based on the dentition data and the first computer model, the geometries of the set of indirect bond trays using the set of rules designed to optimize transfer accuracy of the one or more orthodontic appliances to the one or more respective teeth of the patient includes: determining that a condition in which a particular rule of the set of rules would apply is met; and in response to determining that the condition is met, applying the particular rule to the second computer model of the indirect bond trays.

In some embodiments, the techniques described herein relate to a method, wherein applying the particular rule to the second computer model of the indirect bond trays includes modifying the second computer model of the indirect bond trays.

In some embodiments, the techniques described herein relate to a method, wherein applying the particular rule to the second computer model of the indirect bond trays includes segmenting an indirect bond tray of the set of indirect bond trays.

In some embodiments, the techniques described herein relate to a method, wherein applying the particular rule to the second computer model of the indirect bond trays includes limiting a particular number of teeth for which an indirect bond tray of the set of indirect bond trays can be used for transfer of the one or more orthodontic appliances.

In some embodiments, the techniques described herein relate to a method, wherein applying the particular rule to the second computer model of the indirect bond trays includes using a single indirect bond tray of the set of indirect bond trays for transfer of orthodontic appliances to a particular set of the teeth of the patient.

In some embodiments, the techniques described herein relate to a method, wherein applying the particular rule to the second computer model of the indirect bond trays includes assigning one or more particular teeth of the patient's teeth to a particular indirect bond tray of the set of indirect bond trays.

In some embodiments, the techniques described herein relate to a method, wherein determining the geometries of the set of indirect bond trays using a set of rules includes iteratively applying the set of rules to the second computer model of the set of indirect bond trays.

In some embodiments, the techniques described herein relate to a method, wherein the set of rules designed to optimize transfer accuracy of the one or more orthodontic appliances to the one or more respective teeth are based on one or more of: tooth torque, tip, rotation, and/or angulation; appliance torque, tip, rotation, and/or angulation; appliance placement on location on a tooth; appliance interaction with another tooth and/or another appliance; position of a tooth relative to one or more other teeth; lack of teeth; whether an appliance is to be directly bonded; divergence of teeth; mitigation of material ingress; whether a tooth is planned for extraction; and mitigation of interference between peripheral material of tray and gum tissue.

In some embodiments, the techniques described herein relate to a method, wherein determining, based on the dentition data and the first computer model, the geometries of the set of indirect bond trays using the set of rules includes: generating an initial model of a first set of one or more indirect bond trays; and using the set of rules to modify the first set of one or more indirect bond trays to obtain the set of the indirect bond trays.

In some embodiments, the techniques described herein relate to a method wherein: each indirect bond tray of at least some of the set of indirect bond trays includes: an occlusal base defining one or more impressions conforming to at least a portion of one or more respective occlusal surfaces of the one or more respective teeth; and a buccal wall defining one or more respective wells for removably retaining one or more respective orthodontic appliances adapted to be bonded to the one or more respective teeth, the buccal wall extending substantially orthogonally from the occlusal base; and the method further includes determining a number of the one or more impressions based on the second computer model.

In some embodiments, the techniques described herein relate to a non-transitory computer-readable medium storing instructions that, when executed by a computer hardware processor, cause the computer hardware processor to perform a method for constructing a set of indirect bond trays for transferring one or more orthodontic appliances to one or more respective teeth of a patient, the method including: receiving dentition data associated with a patient; generating a first computer model of teeth of the patient for use in determining placement of the one or more orthodontic appliances on the one or more respective teeth; and generating a second computer model of the set of indirect bond trays, the generating including: determining, based on the dentition data and the first computer model, geometries of the set of indirect bond trays using a set of rules designed to optimize transfer accuracy of the one or more orthodontic appliances to the one or more respective teeth of the patient, wherein the second computer model of the set of indirect bond trays is used in an additive manufacturing process to construct the set of indirect bond trays.

In some embodiments, the techniques described herein relate to a non-transitory computer-readable medium, wherein determining, based on the dentition data and the first computer model, the geometries of the set of indirect bond trays using the set of rules designed to optimize transfer accuracy of the one or more orthodontic appliances to the one or more respective teeth of the patient includes: determining that a condition in which a particular rule of the set of rules would apply is met; and in response to determining that the condition is met, applying the particular rule to the second computer model of the indirect bond trays.

In some embodiments, the techniques described herein relate to a non-transitory computer-readable storage medium, wherein applying the particular rule to the second computer model of the indirect bond trays includes modifying the second computer model of the indirect bond trays.

In some embodiments, the techniques described herein relate to a non-transitory computer-readable storage medium, wherein applying the particular rule to the second computer model of the indirect bond trays includes segmenting an indirect bond tray of the set of indirect bond trays.

In some embodiments, the techniques described herein relate to a non-transitory computer-readable storage medium, wherein applying the particular rule to the second computer model of the indirect bond trays includes limiting a particular number of teeth for which an indirect bond tray of the set of indirect bond trays can be used for transfer of the one or more orthodontic appliances.

In some embodiments, the techniques described herein relate to a non-transitory computer-readable storage medium, wherein applying the particular rule to the second computer model of the indirect bond trays includes using a single indirect bond tray of the set of indirect bond trays for transfer of orthodontic appliances to a particular set of the teeth of the patient.

In some embodiments, the techniques described herein relate to a non-transitory computer-readable storage medium, wherein applying the particular rule to the second computer model of the indirect bond trays includes assigning one or more particular teeth of the patient's teeth to a particular indirect bond tray of the set of indirect bond trays.

In some embodiments, the techniques described herein relate to a non-transitory computer-readable storage medium, wherein determining, based on the dentition data and the first computer model, the geometries of the set of indirect bond trays using the set of rules designed to optimize transfer accuracy of the one or more orthodontic appliances to the one or more respective teeth of the patient includes: determining that a condition in which a particular rule of the set of rules would apply is met; and in response to determining that the condition is met, applying the particular rule to the second computer model of the indirect bond trays.

In some embodiments, the techniques described herein relate to an indirect bond tray for transferring one or more orthodontic appliances to one or more respective teeth of a patient, the tray including: an occlusal base defining one or more impressions conforming to at least a portion of one or more respective occlusal surfaces of the one or more respective teeth; and a buccal wall defining one or more respective wells for removably retaining one or more respective orthodontic appliances adapted to be bonded to the one or more respective teeth, the buccal wall extending substantially orthogonally from the occlusal base, wherein a number of the one or more impressions is determined by a set of rules designed to optimize transfer accuracy of the one or more orthodontic appliances to the one or more respective teeth of the patient.

Example Computer System

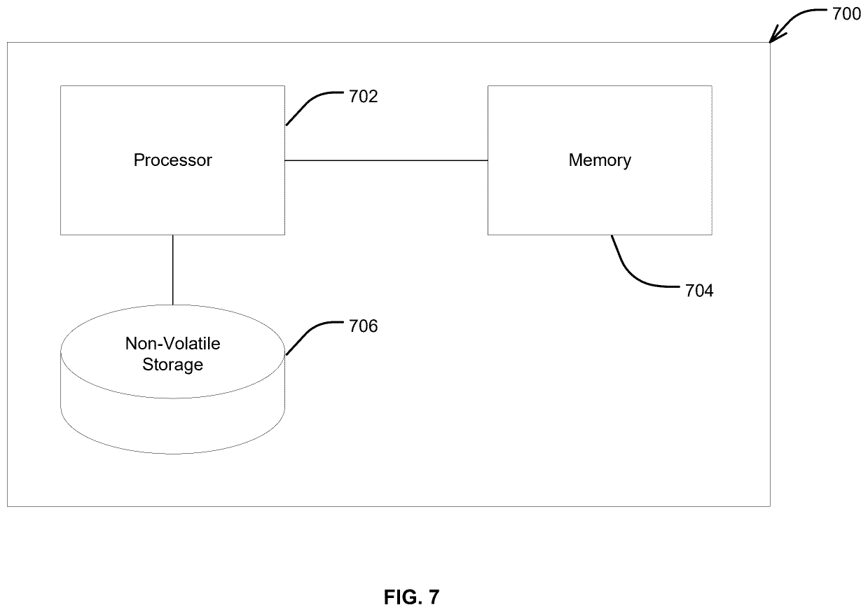

FIG. 7 is a block diagram of an exemplary computing device 700 that may be specially configured to implement some embodiments of the technology described herein. The computer system 700 may include one or more computer hardware processors 702 and non-transitory computer-readable storage media (e.g., memory 704 and one or more non-volatile storage 704). The processor(s) 702 may control writing data to and reading data from (1) the memory 704; and (2) the non-volatile storage device(s) 706. To perform any of the functionality described herein, the processor(s) 702 may execute one or more processor-executable instructions stored in one or more non-transitory computer-readable storage media (e.g., the memory 704), which may serve as non-transitory computer-readable storage media storing processor-executable instructions for execution by the processor(s) 702.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements);etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing,” “involving,” and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method for constructing a set of indirect bond trays for transferring one or more orthodontic appliances to one or more respective teeth of a patient, the method comprising:
receiving dentition data associated with a patient;
generating a first computer model of teeth of the patient for use in determining placement of the one or more orthodontic appliances on the one or more respective teeth;
generating a second computer model of the set of indirect bond trays, the generating comprising:
determining, based on the dentition data and the first computer model, geometries of the set of indirect bond trays using a set of rules designed to optimize transfer accuracy of the one or more orthodontic appliances to the one or more respective teeth of the patient; and
constructing, using an additive manufacturing process, the set of indirect bond trays based on the second computer model.

2. The method of claim 1, wherein determining, based on the dentition data and the first computer model, the geometries of the set of indirect bond trays using the set of rules designed to optimize transfer accuracy of the one or more orthodontic appliances to the one or more respective teeth of the patient comprises:
determining that a condition in which a particular rule of the set of rules would apply is met; and
in response to determining that the condition is met, applying the particular rule to the second computer model of the indirect bond trays.

3. The method of claim 2, wherein applying the particular rule to the second computer model of the indirect bond trays comprises modifying the second computer model of the indirect bond trays.

4. The method of claim 2, wherein applying the particular rule to the second computer model of the indirect bond trays comprises segmenting an indirect bond tray of the set of indirect bond trays.

5. The method of claim 2, wherein applying the particular rule to the second computer model of the indirect bond trays comprises limiting a particular number of teeth for which an indirect bond tray of the set of indirect bond trays can be used for transfer of the one or more orthodontic appliances.

6. The method of claim 2, wherein applying the particular rule to the second computer model of the indirect bond trays comprises using a single indirect bond tray of the set of indirect bond trays for transfer of orthodontic appliances to a particular set of the teeth of the patient.

7. The method of claim 2, wherein applying the particular rule to the second computer model of the indirect bond trays comprises assigning one or more particular teeth of the patient's teeth to a particular indirect bond tray of the set of indirect bond trays.

8. The method of claim 1, wherein determining the geometries of the set of indirect bond trays using a set of rules comprises iteratively applying the set of rules to the second computer model of the set of indirect bond trays.

9. The method of claim 1, wherein the set of rules designed to optimize transfer accuracy of the one or more orthodontic appliances to the one or more respective teeth are based on one or more of:
tooth torque, tip, rotation, and/or angulation;
appliance torque, tip, rotation, and/or angulation;
appliance placement on location on a tooth;
appliance interaction with another tooth and/or another appliance;
position of a tooth relative to one or more other teeth;
lack of teeth;
whether an appliance is to be directly bonded;
divergence of teeth;
mitigation of material ingress;
whether a tooth is planned for extraction; and
mitigation of interference between peripheral material of tray and gum tissue.

10. The method of claim 1, wherein determining, based on the dentition data and the first computer model, the geometries of the set of indirect bond trays using the set of rules comprises:
generating an initial model of a first set of one or more indirect bond trays; and
using the set of rules to modify the first set of one or more indirect bond trays to obtain the set of the indirect bond trays.

11. The method of claim 1 wherein:
each indirect bond tray of at least some of the set of indirect bond trays includes:
an occlusal base defining one or more impressions conforming to at least a portion of one or more respective occlusal surfaces of the one or more respective teeth; and
a buccal wall defining one or more respective wells for removably retaining one or more respective orthodontic appliances adapted to be bonded to the one or more respective teeth, the buccal wall extending substantially orthogonally from the occlusal base; and
the method further comprises determining a number of the one or more impressions based on the second computer model.

12. A non-transitory computer-readable medium storing instructions that, when executed by a computer hardware processor, cause the computer hardware processor to perform a method for constructing a set of indirect bond trays for transferring one or more orthodontic appliances to one or more respective teeth of a patient, the method comprising:
receiving dentition data associated with a patient;
generating a first computer model of teeth of the patient for use in determining placement of the one or more orthodontic appliances on the one or more respective teeth; and
generating a second computer model of the set of indirect bond trays, the generating comprising:
determining, based on the dentition data and the first computer model, geometries of the set of indirect bond trays using a set of rules designed to optimize transfer accuracy of the one or more orthodontic appliances to the one or more respective teeth of the patient,
wherein the second computer model of the set of indirect bond trays is used in an additive manufacturing process to construct the set of indirect bond trays.

13. The non-transitory computer-readable medium of claim 12, wherein determining, based on the dentition data and the first computer model, the geometries of the set of indirect bond trays using the set of rules designed to optimize transfer accuracy of the one or more orthodontic appliances to the one or more respective teeth of the patient comprises:
determining that a condition in which a particular rule of the set of rules would apply is met; and
in response to determining that the condition is met, applying the particular rule to the second computer model of the indirect bond trays.

14. The non-transitory computer-readable storage medium of claim 13, wherein applying the particular rule to the second computer model of the indirect bond trays comprises modifying the second computer model of the indirect bond trays.

15. The non-transitory computer-readable storage medium of claim 13, wherein applying the particular rule to the second computer model of the indirect bond trays comprises segmenting an indirect bond tray of the set of indirect bond trays.

16. The non-transitory computer-readable storage medium of claim 13, wherein applying the particular rule to the second computer model of the indirect bond trays comprises limiting a particular number of teeth for which an indirect bond tray of the set of indirect bond trays can be used for transfer of the one or more orthodontic appliances.

17. The non-transitory computer-readable storage medium of claim 13, wherein applying the particular rule to the second computer model of the indirect bond trays comprises using a single indirect bond tray of the set of indirect bond trays for transfer of orthodontic appliances to a particular set of the teeth of the patient.

18. The non-transitory computer-readable storage medium of claim 13, wherein applying the particular rule to the second computer model of the indirect bond trays comprises assigning one or more particular teeth of the patient's teeth to a particular indirect bond tray of the set of indirect bond trays.

19. The non-transitory computer-readable storage medium of claim 13, wherein determining, based on the dentition data and the first computer model, the geometries of the set of indirect bond trays using the set of rules designed to optimize transfer accuracy of the one or more orthodontic appliances to the one or more respective teeth of the patient comprises:
determining that a condition in which a particular rule of the set of rules would apply is met; and
in response to determining that the condition is met, applying the particular rule to the second computer model of the indirect bond trays.

20. An indirect bond tray for transferring one or more orthodontic appliances to one or more respective teeth of a patient, the tray comprising:
an occlusal base defining one or more impressions conforming to at least a portion of one or more respective occlusal surfaces of the one or more respective teeth; and
a buccal wall defining one or more respective wells for removably retaining one or more respective orthodontic appliances adapted to be bonded to the one or more respective teeth, the buccal wall extending substantially orthogonally from the occlusal base,
wherein a number of the one or more impressions is determined by a set of rules designed to optimize transfer accuracy of the one or more orthodontic appliances to the one or more respective teeth of the patient.
